(19) United States
(12) Patent Application Publication
(10) Pub. No.: US 2016/0028650 A1
(43) Pub. Date: Jan. 28, 2016

(54) METHOD AND SYSTEM FOR A USER TO CREATE FAVORITE SERVER LISTS FOR MULTIPLE SERVICES

(71) Applicant: Aruba Networks, Inc., Sunnyvale, CA (US)

(72) Inventors: Gopal Agarwal, Bangalore (IN); Ramalingeswara Reddy Onteddu, Bangalore (IN); Sachin Shamrao Sanap, Bangalore (IN); Ashish Vyas, Bangalore (IN)

(73) Assignee: Aruba Networks, Inc., Sunnyvale, CA (US)

(21) Appl. No.: 14/340,915

(22) Filed: Jul. 25, 2014

(51) Int. Cl. H04L 12/927; H04L 29/06

(52) U.S. Cl. CPC H04L 47/808; H04L 67/42

(57) ABSTRACT

The present disclosure discloses a method and system for a user to create favorite server lists for multiple services. Specifically, a network device receives a request for a particular service from a client device. Then, from a plurality of network devices that include functionality to provide the particular service, the network device selects a first subset of network devices based on stored data indicating that the first subset of network devices is associated with the client device. The network device further orders the plurality of network devices to obtain an ordered list such that the first subset of network devices is in a more preferred order than a second subset of network devices that are not included in the stored data. The network device next transmits, to the client device, information identifying the first subset of network devices as available devices for providing the particular service.

### FIELD

Embodiments of the present disclosure relate to network client management. In particular, embodiments of the present disclosure describe a method and system for a user to create favorite server lists for multiple services.

### BACKGROUND

In a network deployment, there could be multicast Domain name System (mDNS), Simple Service Discovery Protocol (SSDP), or other similar proxy server implementations that build service database of advertisements from such devices present on virtual local area networks (VLANs) visible to the proxy server. The proxy server can terminate incoming queries and respond to them by looking into its own database, and by applying policies on the entries from its own databases. This network topology can allow visibility of servers based on, e.g., user name, user role, time, location, etc.

When a user's client device sends a query for a particular service, the proxy server responds with many servers from its own database. The user often needs to go through the complete list of servers and identify the particular server which the user is interested in, and then uses service from the particular server.

This approach has a few issues. First, every time when a user receives many servers in response to a service query, the user needs to go through a long list of servers in order to select the server he is interested in. Second, some applications in the user's client device may have restriction on the number of servers the client device can display to the user. Thus, it is possible that the user will not able to view the particular server that the user is interested in, even though the particular server exists in the response to the service query from the proxy server. Third, when the service query is received from a user's client device, the proxy server needs to undergo a complex policy algorithm to find accessible servers for the user based on context of the service query. Moreover, proxy server needs to run the complex policy algorithm for all servers in the large database for the particular service. This process can be time-consuming and inefficient. Fourth, the proxy server may need to send out multiple packets corresponding to all the accessible servers. The additional packets result in more traffic in the network without any real benefit to the client device and/or the network.

### DETAILED DESCRIPTION

In the following description, several specific details are presented to provide a thorough understanding. While the context of the disclosure is directed to network client management, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### BRIEF DESCRIPTION OF THE DRAWINGS

The present disclosure may be best understood by referring to the following description and accompanying drawings that are used to illustrate embodiments of the present disclosure.

FIG. 1 shows an exemplary network environment according to embodiments of the present disclosure.

FIG. 2 shows an exemplary sequence diagram illustrating communication exchanges for a user to create user-defined favorite server lists according to embodiments of the present disclosure.

FIG. 3 shows an exemplary sequence diagram illustrating communication exchanges for a user to create usage-defined favorite server lists according to embodiments of the present disclosure.

FIG. 4 shows an exemplary favorite server list for a particular user according to embodiments of the present disclosure.

FIG. 5 shows an exemplary process for a user to create favorite server lists for multiple services according to embodiments of the present disclosure.

FIG. 6 shows an exemplary process for a user to sort favorite server lists for multiple services according to embodiments of the present disclosure.

FIG. 7 is a block diagram illustrating an exemplary system for a user to create favorite server lists for multiple services according to embodiments of the present disclosure.

### OVERVIEW

Embodiments of the present disclosure relate to network client management. In particular, embodiments of the present disclosure describe a method and system for a user to create favorite server lists for multiple services.

With the solution provided herein, a network device receives a first request for a particular service from a first client device. From a plurality of network devices that include functionality to provide the particular service to the first client device, the network device selects a first subset of one or more network devices based on stored data indicating that the first subset of network devices is associated with the first client device. Then, the network device transmits, to the first client device, first information identifying the first subset of network devices as available devices for providing the particular service.

According to some embodiments of the present disclosure, the network device stores data indicating that a first subset of one or more network devices, of a plurality of network devices comprising functionality to provide a particular service, are associated with a first client device. Then, the network receives a first request for the particular service from the first client device. Subsequently, the network device orders the plurality of network devices to obtain an ordered list such that the first subset of network devices is in a more preferred order than a second subset of network devices. Note that, the second subset of network devices is included in the stored data. Then, the network device transmits the ordered list to the first client device as a list of available network devices for providing the particular service.

### Network Environment

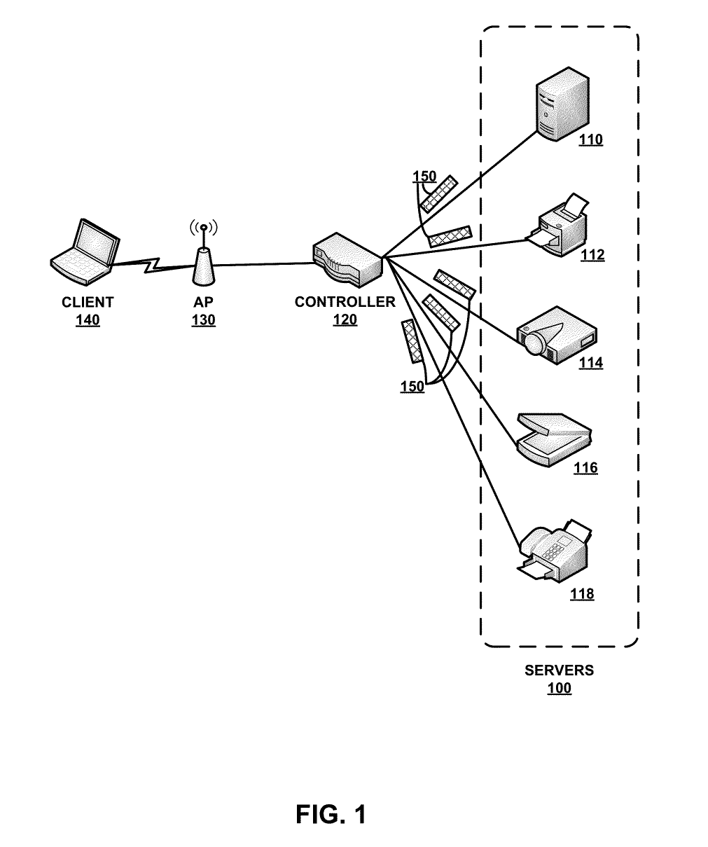

FIG. 1 shows an exemplary network environment according to embodiments of the present disclosure. Specifically, FIG. 1 illustrates a network that includes at least a controller 120, an access point (AP) 130, a client device 140, a plurality of servers providing a variety of network services that include, but are not limited to, server 110, printer 112, projector TV 114, scanner 116, fax 118, etc. Each server can periodically transmit a service advertisement packet 150 to controller 120.

Controller 120 generally refers to a network controlling device that manages other network devices such as wireless access points. Controller 120 may handle automatic adjustments to radio frequency power, wireless channels, wireless authentication, and/or security. Controller 120 can be part of a mobility domain to allow clients access throughout large or regional enterprise facility locations. This saves the clients time and administrators overhead because it can automatically re-associate or re-authenticate.

Furthermore, Controller 120 can serve as a proxy server. A proxy server generally refers to a server (e.g., a computer system or an application) that acts as an intermediary for requests from client devices seeking resources from other servers. A client device connects to the proxy server, requesting some service, such as a file, connection, web page, printing, projecting, or other resource available from a different server. The proxy server evaluates the request as a way to simplify and control its complexity, for example, by applying policies to filter the responses.

In some embodiments, upon receiving service advertisement packet 150, controller 120 can store the advertisement information in an internal and/or external storage memory, such as a database. The advertisement information includes, but is not limited to, the particular type of service provided, the name of the server, the location of the server, the Media Access Control (MAC) and/or Internet Protocol (IP) address of the server, the time period during which the advertisement is good for, etc. Controller 120 may remove an entry corresponding to a particular advertisement if the time period for the particular advertisement expires.

Access points, e.g., AP 130, generally refer to a set of wireless network devices that allow wireless client devices to connect to a wired network using IEEE 802.11 or related standards. The APs usually connect to a router via a wired network, but can also be an integral component of the router itself.

Furthermore, each access point serves one or more client devices. For example, client device 140 is associated with AP 130. A client device (also referred to as a “station” or “STA”) is a device that has the capability to use the IEEE 802.11 protocol. For example, a client device may be a laptop, a desktop computer, a personal data assistant, a smartphone, etc. An STA may be fixed, mobile, or portable. The term “station,” “wireless client,” “client device,” etc., are used interchangeably in the present disclosure unless otherwise stated.

In the illustrated example, AP 130 can forward network controller 120 messages received from client device 140. The messages may include, for example, a service query message, a service selection message, a server selection message, a favorite server list message, etc. Similarly, AP 130 can forward to client device 140 network messages received from network controller 120. Such network messages may include, for example, a service response message, an available server list, a favorite server list, etc.

When network controller 120, receives a service query from a client device 140, network controller 120 will look up its policy database to determine a set of policies applicable to client device 140's service query. Note that, the set of policies by themselves are not sufficient to solve the above-described problems for a few reasons. First, the enforcement of some policies (e.g., user name or user role based policies) relies on establishment of ownership between the client device and the user. If the ownership of device is not defined, then the policies cannot be enforced. Second, a network may be configured with a large number of complex policies that are difficult to enforce. Third, the policies are usually configured by the network administrators of the network. As such, the policies may be not defined to match the user's preferences. Finally, the result sets after application of the policies can be still large. Thus, additional mechanism is needed to sort the large result sets.

Then, network controller 120 will look up a set of servers based on the service query from the database storing service advertisements previously received from other servers. Controller 120 will also apply the set of policies to the set of servers retrieved from the database, and return the result in a response to client device 140. In some embodiments, the database includes a favorite server list (as described below) for each client device managed by controller 120.

### Favorite Server List

Embodiments of the present disclosure provide a mechanism at a proxy server that builds list of servers of interest for a particular user and responds the particular user's service query with the stored favorite server list. In some embodiments, a favorite server list can be stored for each service offered and/or supported by the proxy server.

In general, there can be two types of favorite server list, namely, user-defined favorite server list and usage-defined favorite server list. First, the favorite server list can be defined by a user via an application installed on the user's client device. The application interacts with the proxy server using well known interfaces. Second, the favorite server list could be created based on heuristic usage pattern of the particular user as observed by the proxy server.

A. User-Defined Favorite Server List

In order for a controller and/or proxy server to create a user-defined favorite server list for a particular user, the particular user needs to have a client-side application installed on the user's client device. The client-side application will interact with the controller and/or proxy server. The discovery of the proxy server by the client application may be done independently.

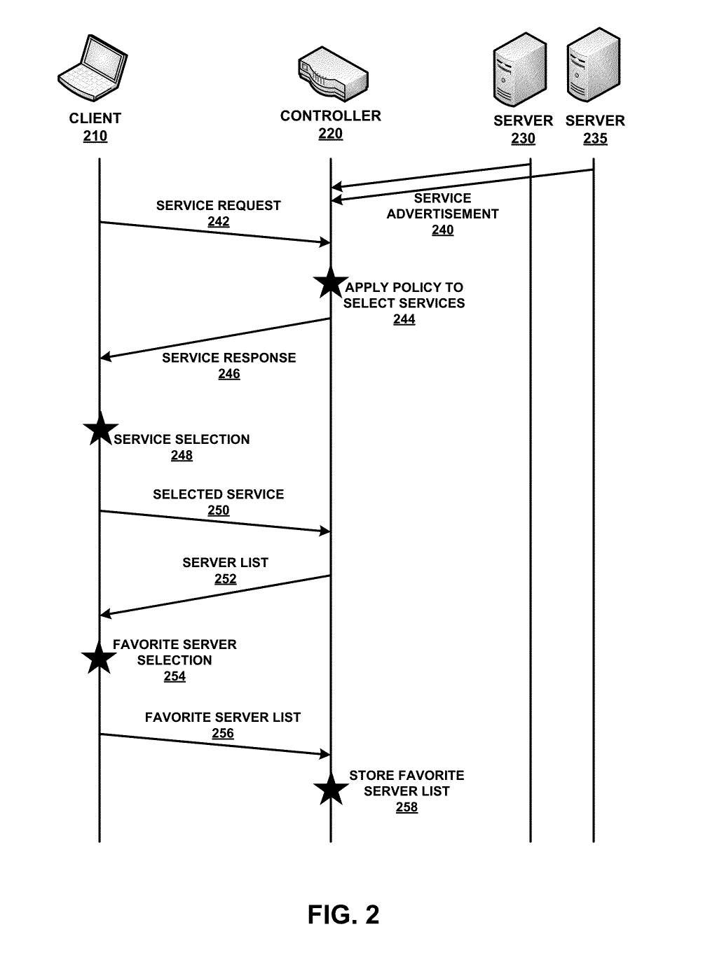

FIG. 2 shows an exemplary sequence diagram illustrating communication exchanges for a user to create user-defined favorite server lists according to embodiments of the present disclosure. FIG. 2 includes at least a client device 210, a controller 220 acting as a proxy server, a number of servers such as server 230 and server 235 providing a number of services.

During operations, each server periodically transmits a service advertisement message 240 to the network. Service advertisement message 240 can be a multicast and/or broadcast message. When controller 220 receives such messages, controller 220 will store service advertisement messages 240 to an internal or external storage. The storage stores all services supported by the proxy server, e.g., controller 220, as well as a list of servers providing each service. If a user has defined the user-defined favorite server lists, these lists will be stored in the storage as well.

Initially, the client-side application on client device 210 sends a service request message 242 to controller 220. Service request message 242 typically requests a receiving server to return a list of service types offered by the receiving server. When a proxy server (e.g., controller 220) receives service request message 242, controller 220 may optionally apply a set of pre-configured policies to select a subset of services supported by the proxy server (e.g., controller 220). Then, the proxy server (e.g., controller 220) responds to client device 210 with a service response message 246, which lists the service types offered by the proxy server (e.g., controller 220).

Next, client device 210 makes a service selection 248 to select one of the service types offered in service response message 246. Then, client device 210 sends a message to the proxy server (e.g., controller 220) indicating selected service 250. The message requests the proxy server (e.g., controller 220) to provide complete list of servers for the selected service type. When the message is received by the proxy server (e.g., controller 220), proxy server (e.g., controller 220) will return a message with a server list 252. Server list 252 typically includes all existing servers for the service type corresponding to selected service 250. When client device 210 receives the server list, client device 210 can make a favorite server selection 235 to add the server to its user-defined favorite server list.

In some embodiments, server list 250 only includes servers that the user can discover and user based on the policies configured on controller 220. In some embodiments, server list 250 includes all servers providing selected service 250 regardless of whether the user of client device 210 can discover or use the server. If, besides all accessible servers for the user, the proxy server (e.g., controller 220) also sends servers that are currently inaccessible to the user due to, e.g., policy restrictions, the proxy server can also send a message to client device 210 indicating the servers that are inaccessible and the reasons why these servers are inaccessible by the user. If the user is interested in consuming service from any of the inaccessible servers, the user can send a request to a network administrator to obtain access for the inaccessible server. After the network administrator grants the user access to the server, the client-side application on client device 210 can send another service request (similar to selected service message 250) to refresh the accessible server list. The proxy server (e.g., controller 220) will return an updated server list indicating that the previously inaccessible server is now accessible to the user. When client device 210 receives the updated accessible server list, client device 210 will be able to make a favorite server selection 235 to add the server to its user-defined favorite server list.

Thereafter, the user-defined favorite server list 256 is transmitted by client device 210 to the proxy server (e.g., controller 220). The proxy server (e.g., controller 220) can then store the user-defined favorite server list 258.

If a subsequent server request is received by the proxy server (e.g., controller 220) from client device 210, the proxy server (e.g., controller 220) will return the stored user-defined favorite server list 258 at least as a part of response. In some embodiments, a user can decide to receive only the user-defined favorite service list. In some embodiments, the user may receive the user-defined favorite server list supplemented by other accessible servers as well. In some embodiments, a user can manually add a server to the user-defined favorite server list that is not on the network yet.

Note that, this communication exchanges between client device 210 and controller 220 acting as the proxy server may not adhere to a specific service discovery protocol. Rather, they can leverage any existing or a completely orthogonal messaging mechanism.

Favorite server list is user-specific. Thus, appropriate security mechanism shall be put in place at the proxy server (e.g., controller 220) before updating the favorite server list database for a given user. This is to make sure that a user is not allowed to tamper other users' favorite server list.

B. Usage-Defined Favorite Server List

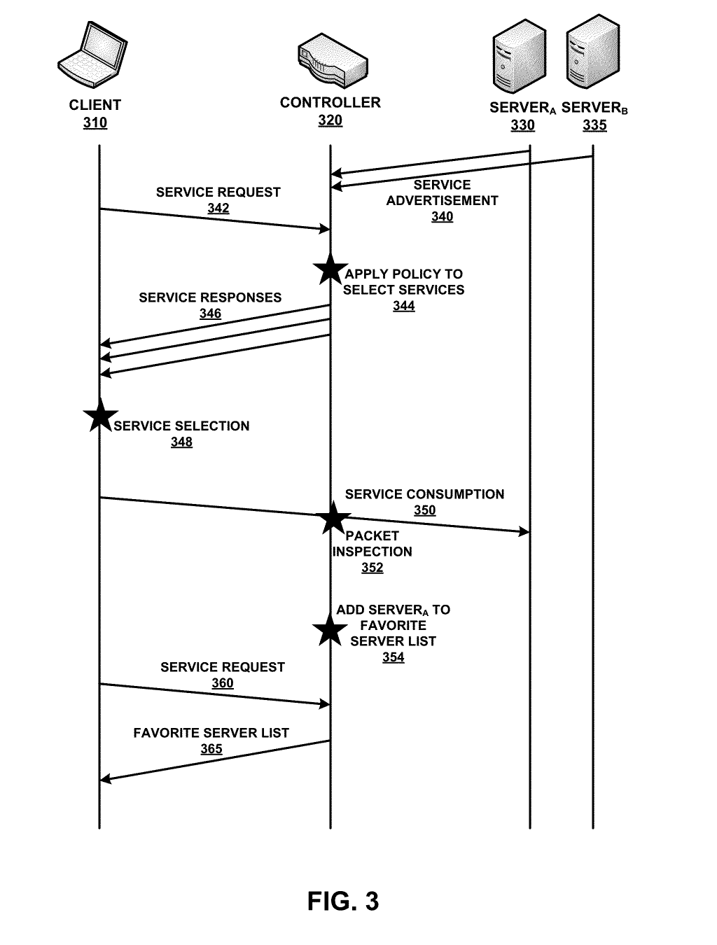

FIG. 3 shows an exemplary sequence diagram illustrating communication exchanges for a user to create usage-defined favorite server lists according to embodiments of the present disclosure. FIG. 3 includes at least a client device 310, a controller 320 acting as a proxy server, a number of servers such as Server_{A} 330 and Server_{B} 335 providing a number of services.

During operations, each server periodically transmits a service advertisement message 340 to the network. Service advertisement message 340 can be a multicast and/or broadcast message. When controller 320 receives such messages, controller 320 will store service advertisement messages 340 to an internal or external storage. The storage stores all services supported by the proxy server, e.g., controller 320, as well as a list of servers providing each service. Once service advertisement message 340 is stored at controller 320 acting as the proxy server, controller 320 will not forward such service advertisement message 340 to client device 310.

Unlike in user-defined favorite server list, when controller 320 creates a usage-defined favorite server list, client device 310 is not required to install a client-side application to interact with the proxy server. Rather, a client device 310 can send a standard service request message 342 as, for example, a mDNS message, SSDP message, etc., to controller 320 acting as the proxy server. Service request message 342 typically requests a receiving server to return a list of service types offered by the receiving server. When a proxy server (e.g., controller 320) receives service request message 342, the proxy server (e.g., controller 320) may optionally apply a set of pre-configured policies to select a subset of services supported by the proxy server (e.g., controller 320). Then, the proxy server (e.g., controller 320) responds to client device 310 with one or more service response messages 346, which lists the service types offered by the proxy server (e.g., controller 320).

Next, client device 310 makes a service selection 348 to select one of the service types offered in service response message 346. Then, client device 310 communicates with the selected server, e.g., Server_{A} 330. The message sent by client device 310 is forwarded to the selected server Server_{A} 330 by controller 320 acting as the proxy server. Specifically, when the message is received by the proxy server (e.g., controller 320), proxy server (e.g., controller 320) will perform a packet inspection to determine at least a service identifier that identifies the service that client device 310 consumes based on a port number. Furthermore, the proxy server (e.g., controller 320) can determine a server identifier that identifies the server (e.g., Server_{A} 330) providing the service to client device 310 based on the destination address of the inspected packet. The proxy server can observe the usage pattern based on the collected service and/or server identifiers associated with a particular user over time, and derive a usage-based favorite server list for the particular user. For example, if the proxy server (e.g., controller 320) observes that client device 310 has exchanged packets frequently with Server_{A} 330 after receiving a previous service request corresponding to a service that Server_{A} 330 provides, then the proxy server (e.g., controller 320) can determine that Server_{A} 330 should be added to the usage-defined favorite server list for client device 310.

If a subsequent service request 360 is received by the proxy server (e.g., controller 320) from client device 310, the proxy server (e.g., controller 320) will return the stored usage-defined favorite server list 365 at least as a part of response.

C. Favorite Server List Response by Proxy Server

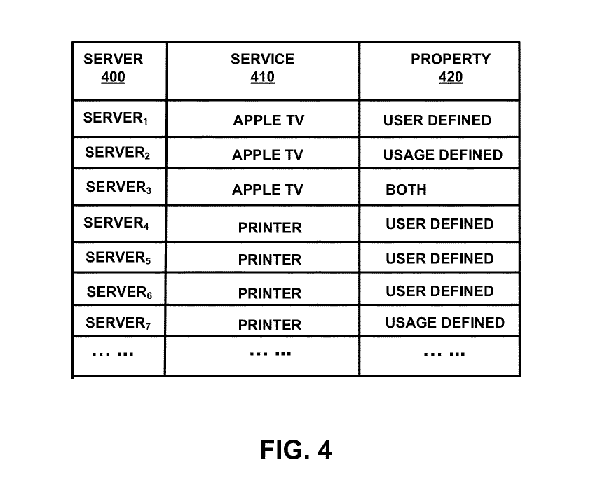

FIG. 4 shows an exemplary process for a user to create favorite server lists for multiple services according to embodiments of the present disclosure. FIG. 4 includes a server field 400, a service field 410, and a property field 420. Server field 400 indicates an identifier of the server. Service field 410 indicates a type of service provided by the server, for example, Apple® TV, printer, etc. Property field 420 indicates a property of the server, for example, user-defined, usage-defined, both, accessible, inaccessible, etc.

In some embodiments, the favorite server list only includes servers that the user can discover and user based on the policies configured on the controller acting as the proxy server. In some embodiments, the favorite server list response includes all servers providing selected service regardless of whether or not the user of client device can discover or use the server. Thus, besides all accessible servers for the user, the proxy server also sends the list of servers that are currently inaccessible.

Note that, inaccessible servers generally refer to servers that provide the requested service however the service is unavailable to the user due to, for example, policy restrictions. The proxy server can also send a message to client device indicating the servers that are inaccessible and the reasons why these servers are inaccessible by the user. If the user is interested in consuming service from any of the inaccessible servers and the server is inaccessible due to lack of authorization, the user can send a request to a network administrator to obtain access for the inaccessible server. As another example, a user may not be able to access a server due the user being located inside or outside a specific region. Thus, when presented the reason why a desired server is inaccessible, if the user desires to consumer the service from the inaccessible server, the user can move to a new location, rendering the server accessible to the user.

As mentioned above, the proxy server terminates the query packets send by a client device, and responds from the favorite server list (e.g., user-defined favorite server list, usage-defined server list, and/or both) for a given service.

The proxy server can respond to the actual service discovery query in a few different ways. For example, in some embodiments, the proxy server responds with only user-defined server list selected by the user via the client-side application installed on a client device of the user. In some embodiments, the proxy server responds with all accessible servers in a preferred order. For example, the ordered list may include the user-defined favorite server list, followed by the usage-defined favorite server list, and followed by other accessible servers. If a server is both user-defined and usage-defined, the favorite server list response from the proxy server will indicate so as well.

By providing a prioritized favorite server list, the proxy server can ensure that the favorite servers are included in the initial response packets to the client device when a large number of responses are sent to the client device. Therefore, even if a user's client-side application may have restriction and can only show a limited number of servers, the user's favorite servers will still be shown in that limited list.

In some embodiments, the proxy server responds with all favorite servers and having limitation on other accessible servers. In some embodiments, th proxy server may respond with only the list or it may prioritize the list in the response message(s). The list could be specific to each client device of given user, or it could be the same for all client devices of given user.

In some embodiments, the user can be presented with an option as to what kind or combination of favorite server list that the user desires to receive from the proxy server. The option could be selected based on user's choice, or it could be a deployment wide configuration option.

Furthermore, a user is allowed to update the user's favorite server list. The proxy server stores favorite server lists of every user for different services. Moreover, the proxy server stores this information for a defined time which is configurable by a network administrator. Therefore, even if a user is away from the network, this information is still maintained by the proxy server, such that user does not need to create favorite server list every time when the user disconnects and reconnects with the network.

At any point of time if user wishes to see all accessible servers, user can go to the application and delete the favorite server list. After deleting the favorite list, application in user's devices sends this info to proxy server. Subsequent to that every query from user gets response from proxy server which contains all accessible servers by that user.

### Process for a User to Create Favorite Server Lists for Multiple Services

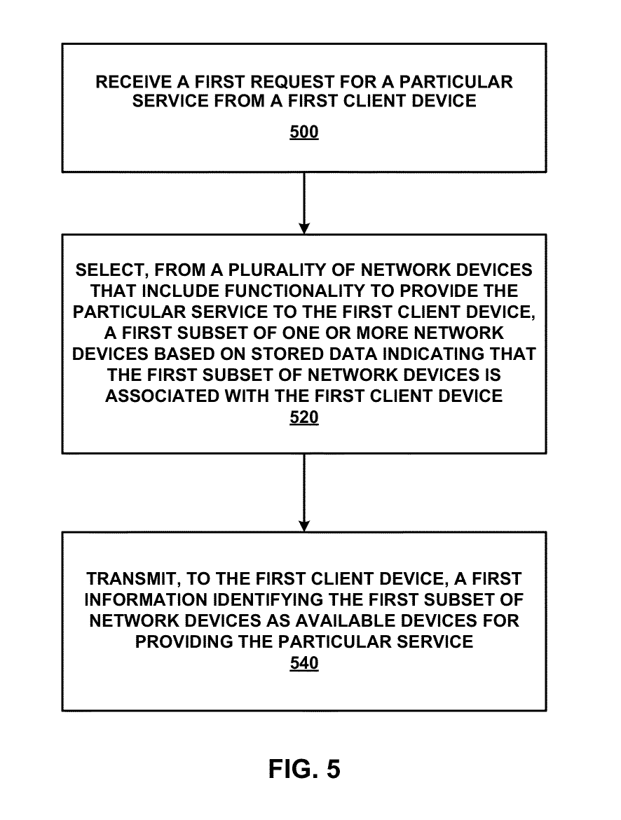

FIG. 5 shows an exemplary process for a user to select favorite server lists for multiple services according to embodiments of the present disclosure. During operations, a network device receives a first request for a particular service from a first client device (operation 500). From a plurality of network devices that include functionality to provide the particular service to the first client device, the network device selects a first subset of one or more network devices based on stored data indicating that the first subset of network devices is associated with the first client device (operation 520). Then, the network device transmits, to the first client device, a first information identifying the first subset of network devices as available devices for providing the particular service (operation 540). Note that, the first subset of network devices are selected from the plurality of network devices for storing in association with the first client device based on prior selection of each network device of the first subset of network devices.

In some embodiments, prior to receiving the first request for the particular service from the first client device, the network device also receives user input selecting the first subset of network devices. Based on the user input, the network device stores the data indicating that the first subset of network devices is associated with the first client device.

In some embodiments, prior to receiving the first request for the particular service from the first client device, the network device receives a previous request for the particular service from the first client device. Then, the network device transmits, to the first client device, a second information identifying the plurality of network devices. Furthermore, the network device receives, from the first client device, a selection of a particular network device for accessing the particular service. Responsive to receiving the selection of the particular network device, the network device can add the particular network device to the first subset of network devices that are identified in the stored data.

In some embodiments, prior to receiving the request for the particular service from the first client device, the network device determines a location of the first client device. Then, the network device further identifies the first subset of network devices based on an association of each of the first subset of network devices with the location. Also, the network device stores the data indicating that the first subset of network devices is associated with the first client device.

In some embodiments, the network device receives a second request for the particular service from a second client device. From the plurality of network devices (e.g., a plurality of servers), the network device selects a second subset of one or more network devices based on a second stored data indicating that the second subset of network devices is associated with the second client device. Further, the network device transmits, to the second client device, a second information identifying the second subset of network devices as available devices for providing the particular service. Here, the first subset of network devices is different than the second subset of network devices.

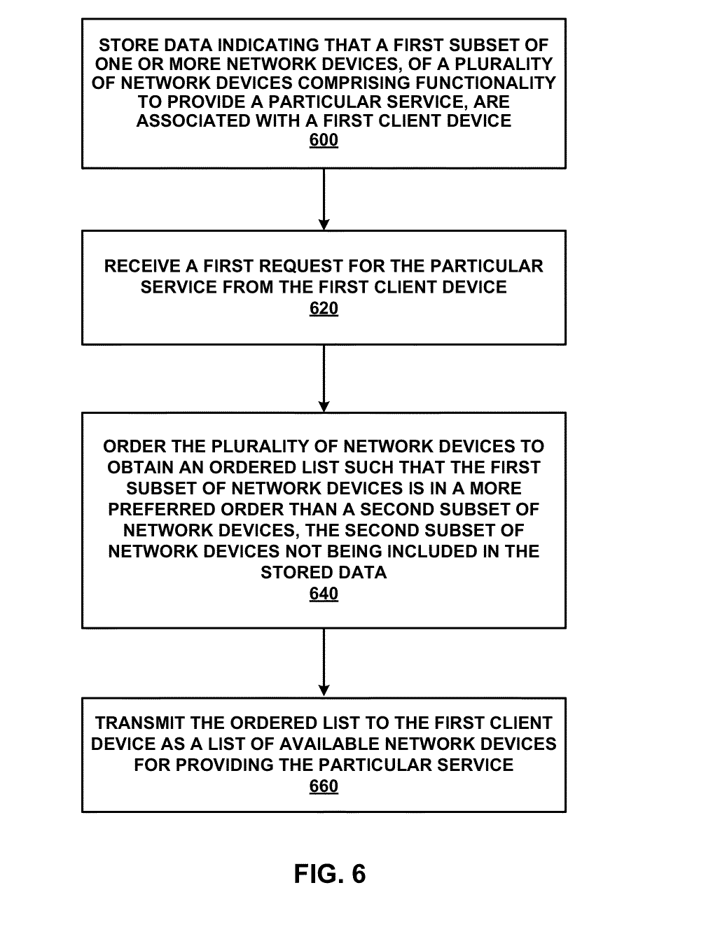

FIG. 6 shows an exemplary process for a user to sort favorite server lists for multiple services according to embodiments of the present disclosure. Specifically, a network device stores data indicating that a first subset of one or more network devices, of a plurality of network devices comprising functionality to provide a particular service, are associated with a first client device (operation 600). The network device also receives a first request for the particular service from the first client device (operation 620). Moreover, the network device orders the plurality of network devices to obtain an ordered list such that the first subset of network devices is in a more preferred order than a second subset of network devices, the second subset of network devices not being included in the stored data (operation 640). Then, the network device transmits the ordered list to the first client device as a list of available network devices for providing the particular service (operation 660).

In some embodiments, the first subset of network devices are selected from the plurality of network devices for storing in association with the first client device based on prior selection of each network device of the first subset of network devices. In some embodiments, the second subset of network devices are selected from the plurality of network devices for storing in association with the first client device based on observation that the first client device previously used the particular service from each network device of the second subset of network devices.

### System for a User to Create Favorite Server Lists for Multiple Services

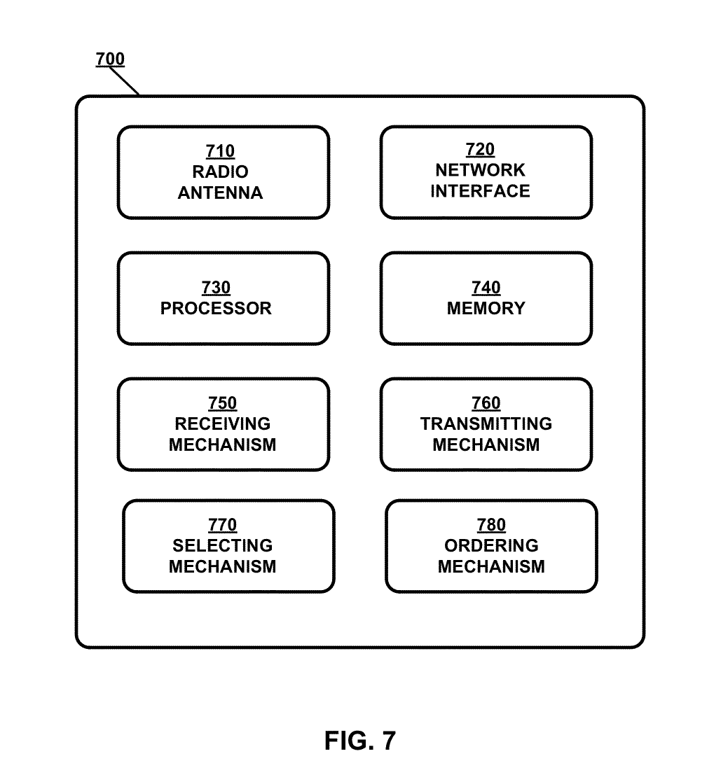

FIG. 7 is a block diagram illustrating an exemplary system for a user to create favorite server lists for multiple services according to embodiments of the present disclosure. Network device 700 includes at least one or more radio antennas 710 capable of either transmitting or receiving radio signals or both, a network interface 720 capable of communicating to a wired or wireless network, a processor 730 capable of processing computing instructions, and a memory 740 capable of storing instructions and data. Moreover, network device 700 further includes a receiving mechanism 750, a transmitting mechanism 760, a selecting mechanism 770, and an ordering mechanism 780, all of which are in communication with processor 730 and/or memory 740 in network device 700. Network device 700 may be used as a client system, or a server system, or may serve both as a client and a server in a distributed or a cloud computing environment.

Radio antenna 710 may be any combination of known or conventional electrical components for receipt of signaling, including but not limited to, transistors, capacitors, resistors, multiplexers, wiring, registers, diodes or any other electrical components known or later become known.

Network interface 720 can be any communication interface, which includes but is not limited to, a modem, token ring interface, Ethernet interface, wireless IEEE 802.11 interface, cellular wireless interface, satellite transmission interface, or any other interface for coupling network devices.

Processor 730 can include one or more microprocessors and/or network processors.

Memory 740 can include storage components, such as, Dynamic Random Access Memory (DRAM), Static Random Access Memory (SRAM), etc. In some embodiments, based on a user input, memory 740 can store data indicating that a subset of network devices is associated with a client device. Specifically, the stored data may indicate that the subset of network devices is associated with a user of the client device. In some embodiments, memory 740 can store data indicating that a subset of one or more network devices, of a plurality of network devices comprising functionality to provide a particular service, are associated with a client device;

Receiving mechanism 750 generally receives one or more network messages via network interface 720 or radio antenna 710 from a wireless client. The received network messages may include, but are not limited to, requests and/or responses, beacon frames, management frames, control path frames, and so on. Specifically, receiving mechanism 750 can receiving a first request for a particular service from a client device. Prior to receiving the first request for the particular service from the client device, receiving mechanism 750 can also receive a user input selecting a first subset of network devices. Furthermore, prior to receiving the first request for the particular service, from a client device, receiving mechanism 750 can receive a previous request for the particular service from the client device.

In some embodiments, receiving mechanism 750 can receive, from a client device, a selection of a particular network device for accessing the particular service. In some embodiments, receiving mechanism 750 receives a first request for the particular service from a first client device, and subsequently receives a second request for the particular service from a second client device.

Transmitting mechanism 760 generally transmits messages, which include, but are not limited to, requests and/or responses, beacon frames, management frames, control path frames, and so on. In some embodiments, transmitting mechanism 760 transmits, to a client device, a first information identifying a first subset of network devices as available devices for providing the particular service. Furthermore, in some embodiments, transmitting mechanism 760 transmits, to the client device, a second information identifying the second subset of network devices as available devices for providing the particular service. Also, transmitting mechanism 760 can transmit the ordered list to the first client device as a list of available network devices for providing the particular service.

Selecting mechanism 770 generally selects a subset of one or more network devices based on stored data. Specifically, selecting mechanism 770 selects from a plurality of network devices that include functionality to provide the particular service to the first client device. In some embodiments, selecting mechanism 770 selects a subset of one or more network devices based on stored data indicating that the first subset of network devices is associated with the first client device. The first subset of network devices are selected from the plurality of network devices for storing in association with the client device based on prior selection of each network device of the subset of network devices.

Moreover, in some embodiments, responsive to receiving the selection of the particular network device, selecting mechanism 770 adds the particular network device to the subset of network devices that are identified in the stored data. Furthermore, prior to receiving the request for the particular service from the first client device, selecting mechanism 770 can determine a location of the first client device, and identify the subset of network devices based on an association of each of the subset of network devices with the location.

Ordering mechanism 780 generally orders the plurality of network devices to obtain an ordered list such that the first subset of network devices is in a more preferred order than a second subset of network devices, the second subset of network devices not being included in the stored data. The first subset of network devices are selected from the plurality of network devices for storing in association with the first client device based on prior selection of each network device of the first subset of network devices. Moreover, the second subset of network devices are selected from the plurality of network devices for storing in association with the first client device based on observation that the first client device previously used the particular service from each network device of the second subset of network devices.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network that links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A non-transitory computer readable medium comprising instructions which, when executed by one or more hardware processors, causes performance of operations comprising:
receiving a first request for a particular service from a first client device;
from a plurality of network devices that include functionality to provide the particular service to the first client device, selecting a first subset of one or more network devices based on stored data indicating that the first subset of network devices is associated with the first client device;
transmitting, to the first client device, a first information identifying the first subset of network devices as available devices for providing the particular service.

2. The medium of claim 1, wherein the first subset of network devices are selected from the plurality of network devices for storing in association with the first client device based on prior selection of each network device of the first subset of network devices.

3. The medium of claim 1, wherein the operations further comprise:
prior to receiving the first request for the particular service from the first client device:
receiving user input selecting the first subset of network devices;
based on the user input, storing data indicating that the first subset of network devices is associated with the first client device.

4. The medium of claim 1, wherein the operations further comprise:
prior to receiving the first request for the particular service from the first client device:
receiving a previous request for the particular service from the first client device;
transmitting, to the first client device, a second information identifying the plurality of network devices;
receiving, from the first client device, a selection of a particular network device for accessing the particular service;
responsive to receiving the selection of the particular network device, adding the particular network device to the first subset of network devices that are identified in the stored data.

5. The medium of claim 1, wherein the operations further comprise:
prior to receiving the request for the particular service from the first client device:
determining a location of the first client device;
identifying the first subset of network devices based on an association of each of the first subset of network devices with the location;
storing the data indicating that the first subset of network devices is associated with the first client device.

6. The medium of claim 1, wherein the plurality of network devices are a plurality of servers.

7. The medium of claim 1, wherein the operations are performed by a controller.

8. The medium of claim 1, wherein the operations further comprise:
receiving a second request for the particular service from a second client device;
from the plurality of network devices, selecting a second subset of one or more network devices based on a second stored data indicating that the second subset of network devices is associated with the second client device;
transmitting, to the second client device, a second information identifying the second subset of network devices as available devices for providing the particular service,
wherein the first subset of network devices is different than the second subset of network devices.

9. The medium of claim 1, wherein the stored data indicates that the first subset of network devices is associated with a user of the first client device.

10. A non-transitory computer readable medium comprising instructions which, when executed by one or more hardware processors, causes performance of operations comprising:
storing data indicating that a first subset of one or more network devices, of a plurality of network devices comprising functionality to provide a particular service, are associated with a first client device;
receiving a first request for the particular service from the first client device;
ordering the plurality of network devices to obtain an ordered list such that the first subset of network devices is in a more preferred order than a second subset of network devices, the second subset of network devices not being included in the stored data;
transmitting the ordered list to the first client device as a list of available network devices for providing the particular service.

11. The medium of claim 10, wherein the first subset of network devices are selected from the plurality of network devices for storing in association with the first client device based on prior selection of each network device of the first subset of network devices.

12. The medium of claim 10, wherein the second subset of network devices are selected from the plurality of network devices for storing in association with the first client device based on observation that the first client device previously used the particular service from each network device of the second subset of network devices.

13. The medium of claim 10, wherein the operations further comprise:
prior to receiving the first request for the particular service from the first client device:
receiving user input selecting the first subset of network devices;
based on the user input, storing data indicating that the first subset of network devices is associated with the first client device.

14. The medium of claim 10, wherein the operations further comprise:
prior to receiving the first request for the particular service from the first client device:
receiving a previous request for the particular service from the first client device;
transmitting, to the first client device, a second information identifying the plurality of network devices;
receiving, from the first client device, a selection of a particular network device for accessing the particular service;
responsive to receiving the selection of the particular network device, adding the particular network device to the first subset of network devices that are identified in the stored data.

15. The medium of claim 10, wherein the operations further comprise:
prior to receiving the request for the particular service from the first client device:
determining a location of the first client device;
identifying the first subset of network devices based on an association of each of the first subset of network devices with the location;
storing the data indicating that the first subset of network devices is associated with the first client device.

16. The medium of claim 10, wherein the plurality of network devices are a plurality of servers.

17. The medium of claim 10, wherein the operations are performed by a controller.

18. The medium of claim 10, wherein the operations further comprise:
receiving a second request for the particular service from a second client device;
from the plurality of network devices, selecting a third subset of one or more network devices based on a second stored data indicating that the third subset of network devices is associated with the second client device;
transmitting, to the second client device, a second information identifying the third subset of network devices as available devices for providing the particular service,
wherein the third subset of network devices is different than the first subset of network device and the second subset of network devices.

19. The medium of claim 10, wherein the stored data indicates that the first subset of network devices is associated with a user of the first client device.
